(19) United States
(12) Patent Application Publication
(10) Pub. No.: US 2013/0176627 A1
(43) Pub. Date: Jul. 11, 2013

(54) MIRROR ASSEMBLY FOR COMBINING VISIBLE LIGHTS WITH FILTER FUNCTION

(71) Applicants: Lite-On Electronics (Guangzhou) Limited, Guangzhou (CN); Lite-On Technology Corp., Taipei (TW)

(72) Inventors: CHIEH-WEN WANG, TAIPEI (TW); WEI-JIE PENG, TAIPEI (TW); WEI-HWA LEE, TAIPEI (TW)

(73) Assignees: Lite-On Technology Corp., Taipei (TW); Lite-On Electronics (Guangzhou) Limited, Guangzhou (CN)

(21) Appl. No.: 13/716,293

(22) Filed: Dec. 17, 2012

Related U.S. Application Data
(60) Provisional application No. 61/584,849, filed on Jan. 10, 2012.

(30) Foreign Application Priority Data
May 11, 2012 (CN) 201210153746.7

(51) Int. Cl. G02B 27/10

(52) U.S. Cl. CPC G02B 27/1006
USPC 359/634

(57) ABSTRACT

A mirror assembly includes a first mirror and a second mirror. The first mirror passes a first color light therethrough, reflects a second color light and has an average transmittance (T1) of light with a wavelength of 380 nm to 420 nm. The second mirror reflects the first and second color lights from the first mirror, passes a third color light therethrough to mix with the first and second color lights, and has an average transmittance (T2) of light with a wavelength of 380 nm to 420 nm. The first to third color lights are combined at one side of the second mirror, while light having a wavelength of 380 nm to 420 nm travels on the other side of the second mirror.

### CROSS-REFERENCE TO RELATED APPLICATION

This application claims priority of U.S. Patent Application No. 61/584,849, filed on Jan. 10, 2012, and Chinese Patent Application No. 201210153746.7, filed on May 11, 2012.

### BACKGROUND OF THE INVENTION

1. Field of the Invention

The invention relates to a mirror assembly, more particularly to a mirror assembly for combining visible lights with a filter function for use with projection devices.

2. Description of the Related Art

A typical projector that uses a high pressure mercury lamp as its light source often includes an ultraviolet filter (UV-cut filter) to optimally mitigate damage to projector components caused by harmful light, i.e., ultraviolet light. Proper use of the UV-cut filter may result in excellent isolation effect. Generally, the UV-cut filter is placed perpendicular to an optical axis. The current market, however, prefers smaller, portable projectors, leading to light-emitting diodes (LEDs) becoming the primary light source of choice due to their small size, high luminance, and long life.

Currently, color sequential LED projectors routinely use red, blue and green or red, fluorescent green and blue LEDs as light sources. Blue, green and fluorescent green lights inherently contain harmful lights with wavelengths ranging from 380 nm to 420 nm. These harmful lights can readily damage plastic lenses used in the projector. More particularly, within the wavelength range of 380 nm to 400 nm, the fluorescent green light emits a percentage of radiation of 0.15%, the green light emits a percentage of radiation of 0.01%, and the blue light emits a percentage of radiation of 0.14%. Within the wavelength range of 400 nm to 420 nm, the fluorescent green light emits a percentage of radiation of 1.3%, the green light emits a percentage of radiation of 0.03%, and the blue light emits a percentage of radiation of 0.46

Modern projectors have shifted away from glass lenses in favor of plastic lenses because plastics are easily formed into specific shapes than glasses. A plastic material with a high refractive index and a low Abbe number is used to correct aberration and to improve image quality. However, because lens made from this kind of plastic material readily absorbs light in a wavelength of less than 420 nm, when intense light energy is excessively accumulated, the lens is likely to turn into yellow, thereby shortening the service life of the lens.

Harmful lights (defined by the present invention as lights within the wavelength range of 380 nm to 420 nm) damage not only the plastic lens within the projector, but may also degrade modulation elements of digital imaging devices, such as DMD, LCoS, etc. Therefore, in order to satisfy current market requirements, the issue presented is how to reduce or filter out the harmful lights and thus preserve the lifespan of the projector's optical engine.

Although the aforesaid projector can achieve filtering out harmful UV rays using the UV-cut filter, it has these drawbacks: First, the UV-cut filter can only be used at certain angles, generally ±25° from the optical axis to prevent light leakage. Second, the UV-cut filter may require as many as twenty coating layers, so that the cost thereof is high. Third, the UV-cut filter can diminish the light source energy, thus decreasing the projector's overall efficiency. Last, the projector must allocate a space for accommodating the UV-cut filter, thereby increasing the overall size and weight of the projector, running counter to the market's preference for smaller, portable models. Therefore, there is room for improvement in this field.

### SUMMARY OF THE INVENTION

Therefore, an object of the present invention is to provide a mirror assembly for combining visible lights with a filter function and that can reduce the number of components in a projection device, thereby decreasing the cost and size thereof.

According to one aspect of this invention, a mirror assembly for combining visible lights with a filter function comprises a first mirror and a second mirror disposed at one side of the first mirror. The first mirror is configured to pass a first color light therethrough and reflect a second color light. The first color light travels in a first direction. The first mirror extends in a direction non-perpendicular to the first direction, and has an average transmittance (T1) of light with a wavelength of 380 nm to 420 nm.

The second mirror extends in a direction non-perpendicular to the first direction, and is configured to reflect the first and second color lights from the first mirror and to pass a third light therethrough so as to mix the third color light with the first and second color lights. The second mirror has an average transmittance (T2) of light with a wavelength of 380 nm to 420 nm. The first color light, the second color light and the third color light are combined at one side of the second mirror, while light having a wavelength of 380 nm to 420 nm travels from the other side of the second mirror.

According to another aspect of this invention, a mirror assembly for combining visible lights with a filter function comprises a first mirror and a second mirror that intersects the first mirror. The first mirror reflects a first color light toward a combined direction, and has an average transmittance of less than or equal to 8% of light with a wavelength of 380 nm to 420 nm. The second mirror reflects a second color light toward the combined direction, and has an average transmittance of less than or equal to 8% of light with a wavelength of 380 nm to 420 nm. A third color light passes through the first mirror and the second mirror in the combined direction to combine with the first color light and the second color light.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view showing the basic configuration of a mirror assembly of the present invention and a projection device;

FIG. 2 is a schematic view of a first embodiment of the mirror assembly according to this invention;

FIG. 3 is a schematic view of a second embodiment of the mirror assembly according to this invention;

FIG. 4 is a schematic view of a third embodiment of the mirror assembly according to this invention;

FIG. 5 is a schematic view of a fourth embodiment of the mirror assembly according to this invention;

FIG. 6 is a schematic view of a fifth embodiment of the mirror assembly according to this invention;

FIG. 7 is a schematic view of a sixth embodiment of the mirror assembly according to this invention;

FIG. 8 is a schematic view of a seventh embodiment of the mirror assembly according to this invention;

FIG. 9 is a schematic view of an eighth embodiment of the mirror assembly according to this invention;

FIG. 10 is a transmittance-wavelength graph of blue-transmitting mirrors (BTM) of this invention and a conventional one;

FIG. 11 is a transmittance-wavelength graph of blue-reflecting mirrors (BRM) of this invention and a conventional one;

FIG. 12 is a transmittance-wavelength graph of red-transmitting mirrors (RTM) of this invention and a conventional one;

FIG. 13 is a transmittance-wavelength graph of red-reflecting mirrors (RRM) of this invention and a conventional one;

FIG. 14 is a transmittance-wavelength graph of green-transmitting mirrors (GTM) of this invention and a conventional one;

FIG. 15 is a transmittance-wavelength graph of green-reflecting mirrors (GRM) of this invention and a conventional one;

FIG. 16 is a transmittance-wavelength graph of an alternative form of the blue-transmitting mirror of this invention;

FIG. 17 is a transmittance-wavelength graph of an alternative form of the blue-reflecting mirror of this invention;

FIG. 18 is a transmittance-wavelength graph of an alternative form of the red-transmitting mirror of this invention;

FIG. 19 is a transmittance-wavelength graph of an alternative form of the red-reflecting mirror of this invention;

FIG. 20 is a schematic view of the mirror assembly of this invention in the form of an X-plate;

FIG. 21 is a schematic view of a ninth embodiment of the mirror assembly according to this invention;

FIG. 22 is a schematic view of a tenth embodiment of the mirror assembly according to this invention; and

FIG. 23 is a schematic view of an eleventh embodiment of the mirror assembly according to this invention.

### DETAILED DESCRIPTION OF THE PREFERRED EMBODIMENTS

The above-mentioned and other technical contents, features, and effects of this invention will be clearly presented from the following detailed description of eleven preferred embodiments in coordination with the reference drawings.

Before the present invention is described in greater detail, it should be noted that like elements are denoted by the same reference numerals throughout the disclosure.

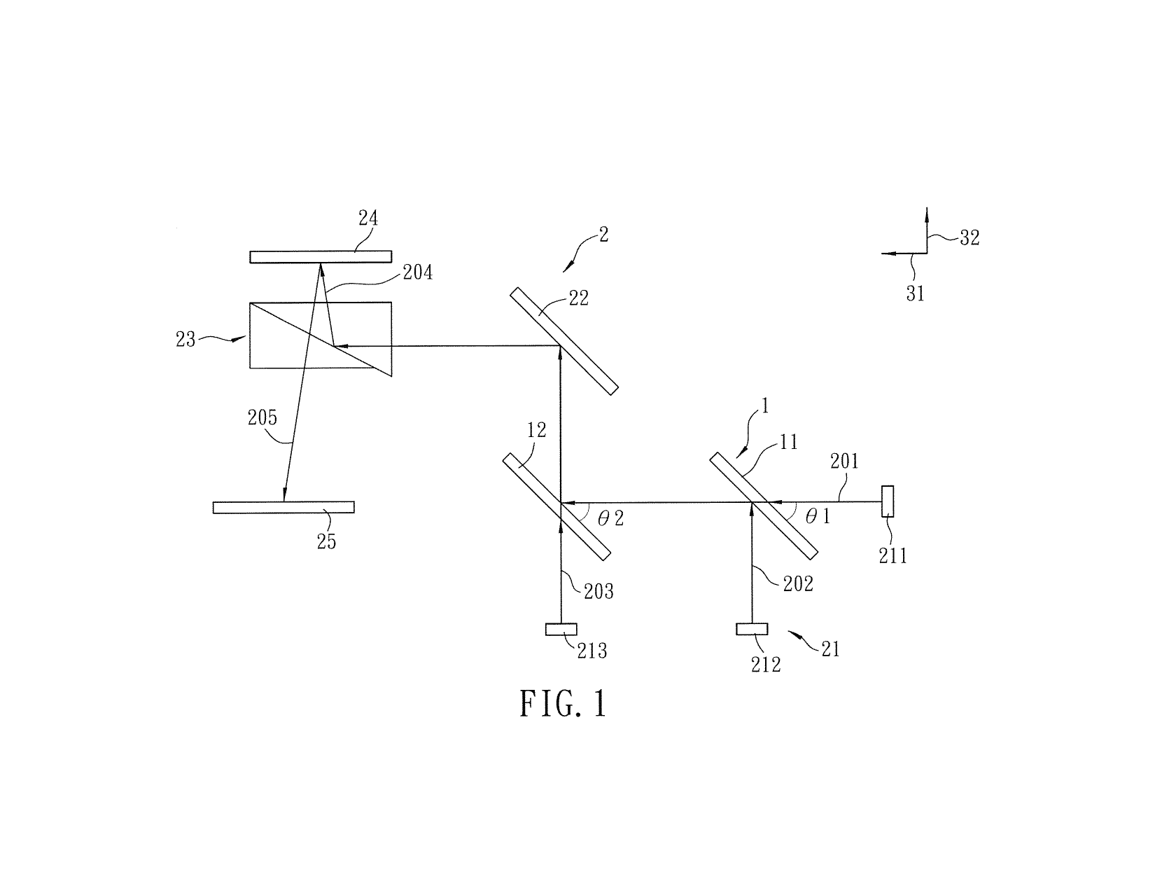

Referring to FIG. 1, the present invention is a mirror assembly 1 for combining visible lights with a filter function used in a projection device 2. The projection device 2 includes a light source unit 21, a reflective mirror 22, a total internal reflection (TIR) lens assembly 23, a digital micromirror device (DMD) 24, and a projection lens 25. The light source unit 21 includes a first light source 211 that emits a first color light 201, a second light source 212 that emits a second color light 202, and a third light source 213 that emits a third color light 203. The first to third light sources 211, 212, 213 may be LEDs or another type of solid-state light source. The first to third color lights 201, 202, 203 may be a combination of red light, green light (including fluorescent green and true green), or blue light. The green and blue lights inherently contain lights with wavelengths ranging from 380 nm to 420 nm that could damage the lenses within the projection device 2. Hereinafter, light with a wavelength of 380 nm to 420 nm will be referred to as “harmful light.”

The first to third color lights 201, 202, 203 are mixed in the mirror assembly 1, and are then reflected toward the TIR prism assembly 23 through the reflective mirror 22. Some portion of light rays reflected from the TIR prism assembly 23 enter the DMD and become illumination rays 204, while other portion of light rays are reflected back to the TIR prism 23 and pass through the projection lens 25 to become projection rays 205 (also known as imaging light). Since the elements of the projection device 2 are not related to the improvements in the present invention, a detailed description of the same will be dispensed herewith.

The mirror assembly 1 of the present invention comprises a first mirror 11 and a second mirror 12 both of which are disposed along the path of travel of the first color light 201.

The first mirror 11 is configured to pass the first color light 201 therethrough and reflect the second color light 202. The first color light 201 travels in a first direction 31 towards the first mirror 11. The first mirror 1 extends in a direction non-perpendicular to the first direction 31. The first mirror 11 has an average transmittance (T1) of light with a wavelength of 380 nm to 420 nm. T1 may be less than or equal to 8% (i.e., T1≦8%), or may be greater than or equal to 95% (i.e., T1≧95%). The extending direction of the first mirror 11 and the first direction 31 form an acute angle (θ1) between 35° and 55°, preferably 45°. The second color light 202 travels in a second direction 32 that is perpendicular to the first direction 31 towards the first mirror 11. Since the first mirror 11 passes the first color light 201 therethrough and reflects the second color light 202, the first color light 201 and the second color light 202 can continuously travel in the first direction 31 towards the second mirror 12.

The second mirror 12 is disposed at one side of the first mirror 11 and extends in a direction non-perpendicular to the first direction 31. The second mirror 12 reflects the first and second lights 201, 202 from the first mirror 11, and passes the third color light 203 therethrough so as to mix the third color light 203 with the first and second color lights 201, 202. The second mirror 12 has an average transmittance (T2) of light with a wavelength of 380 nm to 420 nm. T2 may be less than or equal to 8% (i.e., T2≦8%), or may be greater than or equal to 95% (i.e., T2≧95%). The first, second and third color lights 201, 202, 203 are mixed at one side of the second mirror 12, while the light with a wavelength of 380 nm to 420 nm travels on the other side of the second mirror 12. The extending direction of the second mirror 12 and the first direction 31 form an acute angle (θ2) between 35° and 55°, preferably 45°. The third color light 203 travels in the second direction 32 and passes through the second mirror 12 to combine with the first and second color lights 201, 202. The combined first to third color lights 201, 202, 203 travel in the second direction 32, and ultimately, a portion of the combined light passes through the projection lens 25 to become projection rays 205.

For purposes of clarity only, in this description, the first direction 31 refers to a left-right direction, while the second direction 32 refers to a top-bottom direction, such that each of the first mirror 11 and the second mirror 12 extends from the top left to the bottom right. This is just an example and should not be limited as such. Although the first and second mirrors 11, 12 are disposed spaced apart from each other in the left-right direction, it should not be limited to this disclosure.

Concretely speaking, the first mirror 11 and the second mirror 12 are dichroic mirrors, and each can be either a blue-reflecting mirror (BRM), a blue-transmitting mirror (BTM), a red-reflecting mirror (RRM), a red-transmitting mirror (RTM), a green-reflecting mirror (GRM), or a green-transmitting mirror (GTM). Reflecting mirrors reflect their respective colors and pass the other colors therethrough, while transmitting mirrors pass their respective colors therethrough and reflect the other colors. For example, the blue-reflecting mirror reflects blue light and passes red and green lights therethrough, while the blue-transmitting mirror passes blue light therethrough and reflects red and green lights. In more technical terms, the blue-transmitting mirror is a short pass filter, the red-transmitting mirror is a long pass filter, and the green-transmitting mirror is a band pass filter.

Transmittance refers to the fraction of light at a specified wavelength that is transmitted. For example, if the average transmittance (T1) for the first mirror 11 is less than or equal to 8%, i.e., T1≦8%, the first mirror 11 can reflect a majority of harmful light and pass a small amount therethrough. On the other hand, if T1≧95%, the first mirror 11 can pass the majority of the harmful light therethrough and reflect a small amount. This is analogous for the second mirror 12.

In the present invention, a mirror that transmits a high amount of harmful light is called “HT” or “High Transmittance,” while a mirror that transmits a low amount of harmful light is called “LT” or “Low Transmittance.” The value of transmittance T1, T2 of each of the first mirror 11 and the second mirror 12 depends on the coating material and the number of coating layer. Generally, a mirror includes dozens of coating layers, and has high and low refractive index materials that are arranged in an alternate manner.

Other than the ability to combine three colored lights, the mirror assembly 1 of the present invention also filters out harmful lights using the first mirror 11 and the second mirror 12, so that the harmful lights cannot transmit from the second mirror 12 to the reflective mirror 22, thereby preventing the harmful lights from affecting the subsequent lenses.

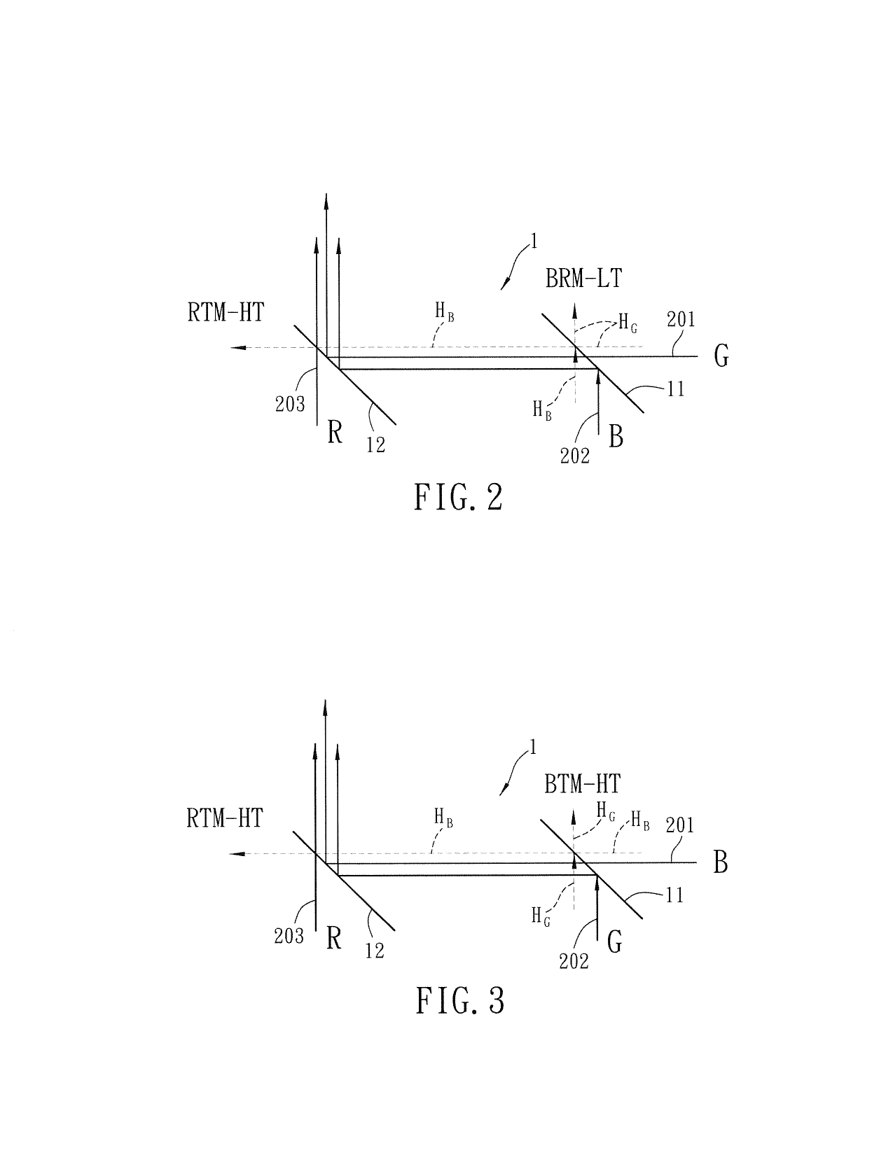

Referring to FIG. 2, the first embodiment of the mirror assembly 1 according to this invention has the first color light 201 that is green, the second color light 202 that is blue, and the third color light 203 that is red. The first color light 201 and the second color light 202 both inherently contain harmful lights which are denoted by imaginary lines (H_{B}, H_{G}). For the sake of clarity, the harmful lights (H_{B}, H_{G}) are drawn separately from the first color light 201 and the second color light 202. In this embodiment, the first mirror 11 is a low transmittance blue-reflecting mirror (BRM-LT) with a T1 of approximately 0.1%, and thus passes only a small amount of harmful light therethrough. The second mirror 12 is a high transmittance red-transmitting mirror (RTM-HT) with a T2 of approximately 96.6%, and thus passes a large amount of harmful light therethrough.

In the use of this embodiment, the first color or green light 201 passes through the first mirror 11 towards the second mirror 12, and is reflected upwardly by the second mirror 12. The second color or blue light 202 is reflected by the first and second mirrors 11, 12 in succession. The third color or red light 203 passes upwardly through the second mirror 12. Thus, the red, blue and green lights 201, 202, 203 are mixed at the second mirror 12 and ultimately enter the projection lens 25. Further, when the green light 201 passes through the first mirror 11, because the first mirror 11 has low transmittance, a large portion of the harmful light carried by the green light 201 is reflected upwardly and subsequently absorbed by a housing of the projection device, and a large portion of the harmful light carried by the blue light 202 is reflected leftward by the first mirror 11 towards the second mirror 12. Since the second mirror 12 has high transmittance, the harmful light reflected by the first mirror 11 passes through the second mirror 12 and is subsequently absorbed by the projection device housing. Thus, this configuration can filter out the majority of harmful lights and prevent the damage to the projection lens 25.

In this embodiment, the first and second mirrors 11, 12 are specially designed, mainly by varying the numbers of coating layers thereof to achieve their respective requisite harmful wavelength transmittance values. This embodiment employs the use of the characteristics of dichroic mirrors coupled with the configuration of the incident position of the RGB lights so that the first and second mirrors 11, 12 can filter out the harmful light by reflection or transmission. Particularly, the harmful light entering the projection device 2 can be reduced by around 90%, thereby preventing damage to the other lenses of the projection device 2, such as DMD or LCoS, the TIR prism assembly 23, the camera lens, etc. Hence, the present invention can increase the service life of the lenses and, consequently, the whole projection device 2. In addition, because the filtering function of this invention is directly integrated with the mirror assembly 1, a separate UV-cut is unnecessary, thereby reducing the internal space requirements for the device, reducing the cost, and negating the impact the UV-cut has on the light source energy, thus improving the efficiency of the projection device 2.

Referring to FIG. 3, the second embodiment of the mirror assembly 1 according to this invention has the same basic structure as the first embodiment. However, in this embodiment, the first color light 201 is blue, the second color light 202 is green, the third color light 203 is red, the first mirror 11 is a high transmittance blue-transmitting mirror (BTM-HT), and the second mirror 12 is a high transmittance red-transmitting mirror (RTM-HT). Because the first mirror 11 has high transmittance, the majority of the harmful light carried by the second color or green light 202 passes upwardly through the first mirror 11 and is subsequently absorbed by the projection device housing. Although the harmful light carried by the first color or blue light 201 passes through the first mirror 11 towards the second mirror 12, because the second mirror 12 also has high transmittance (T2), the majority of the harmful light carried by the blue light 201 passes through the second mirror 12 and is subsequently absorbed by the projection device housing. Hence, damage to the plastic lenses in the device can be greatly reduced.

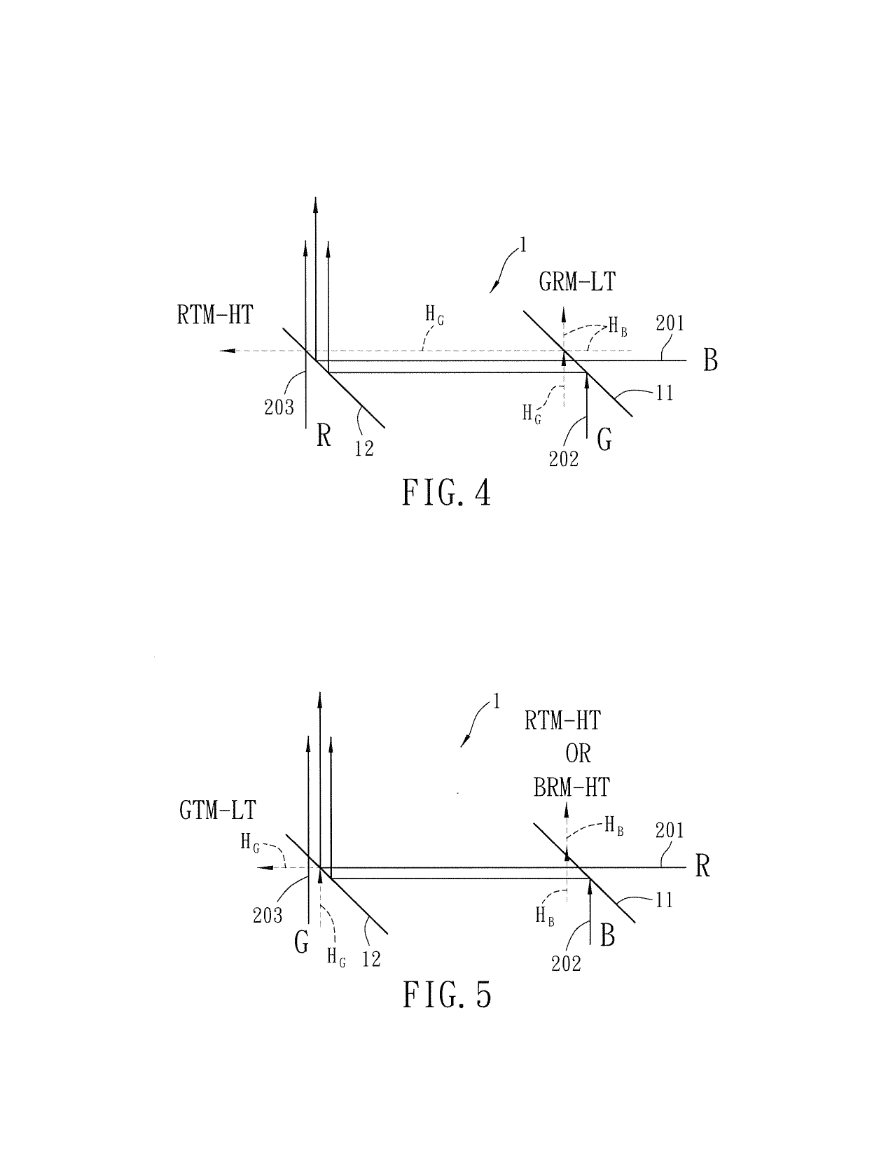

Referring to FIG. 4, the third embodiment of the mirror assembly 1 according to this invention is substantially similar to the second embodiment, the only difference being that the first mirror 11 is a low transmittance green-reflecting mirror (GRM-LT). Hence, the first mirror 11 reflects upwardly the majority of the harmful light carried by the first color or blue light 201 so that it is absorbed by the projection device housing. The majority of the harmful light carried by the second color or green light 202 is reflected by the first mirror 11 towards the second mirror 12. Because the second mirror 12 has high transmittance (T2), the majority of the harmful light reflected by the first mirror 11 passes through the second mirror 12 and is absorbed by the projection device housing.

Generalizing the first three embodiments of this invention, when the third color light 203 is red, and the first color light 201 and the second color light 202 are blue or green that carries harmful light which enters the first mirror 11, the second mirror 12 must have high transmittance (T2), i.e., T2≧95%, to filter out the harmful light.

Referring to FIG. 5, the fourth embodiment of the mirror assembly 1 according to this invention has the same basic structure as the first embodiment. However, in this embodiment, the first color light 201 is red, the second color light 202 is blue, the third color light 203 is green, the first mirror 11 is either a high transmittance blue-reflecting mirror (BRM-HT) or a high transmittance red-transmitting mirror (RTM-HT) and the second mirror 12 is a low transmittance green-transmitting mirror (GTM-LT). The harmful light within the second color or blue light 202 passes upwardly through the first mirror 11 and is absorbed by the projection device housing. The harmful light within the third color or green light 203 is reflected leftwards by the second mirror 12 and is absorbed by the projection device housing.

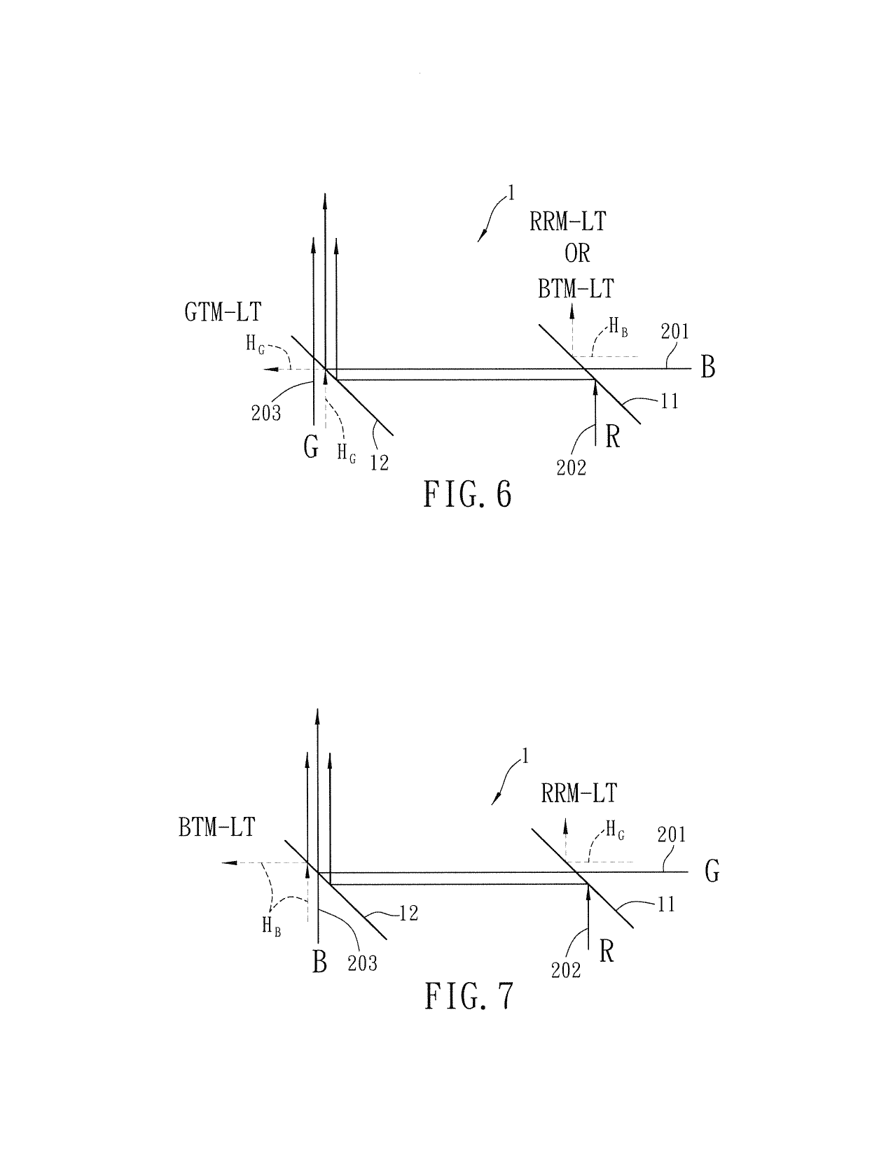

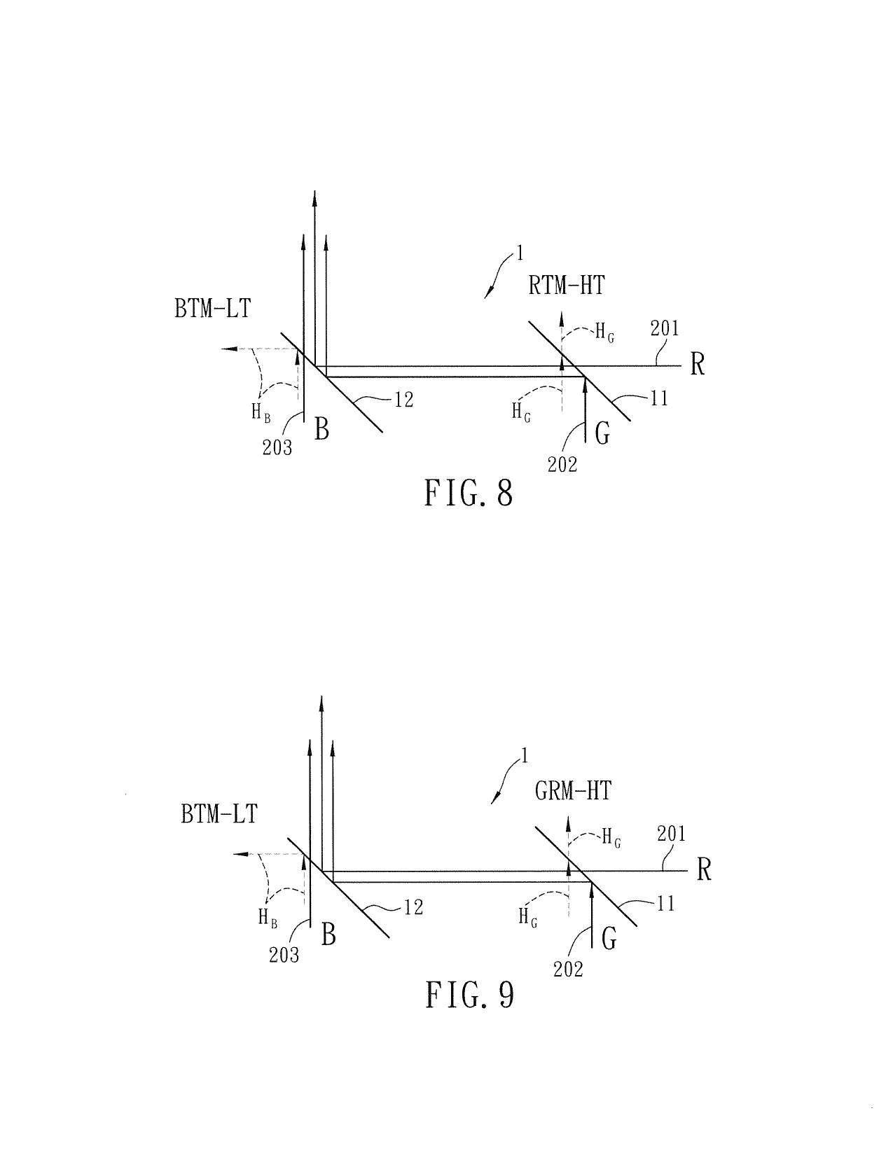

Referring to FIG. 6, the fifth embodiment of the mirror assembly 1 according to this invention has the same basic structure as the first embodiment, differing in that the first color light 201 is blue, the second color light 202 is red, the third color light 203 is green, the first mirror 11 is either a low transmittance blue-transmitting mirror (BTM-LT) or a low transmittance red-reflecting mirror (RRM-LT) and the second mirror 12 is a low transmittance green-transmitting mirror (GTM-LT). The configuration in this embodiment also redirects the harmful light towards the projection device housing and thus protects the plastic lenses. The effect of this embodiment is similar to that described in the first embodiment.

Referring to FIG. 7, the sixth embodiment of the mirror assembly 1 according to this invention has the same basic structure as the first embodiment, differing in that the first color light 201 is green, the second color light 202 is red, the third color light 203 is blue, the first mirror 11 is a low transmittance red-reflecting mirror (RRM-LT) and the second mirror 12 is a low transmittance blue-transmitting mirror (BTM-LT). The configuration in this embodiment also redirects the harmful light towards the projection device housing and thus protects the plastic lenses. The effect of this embodiment is similar to that described in the first embodiment.

Referring to FIG. 6, the seventh embodiment of the mirror assembly 1 according to this invention has the same basic structure as the first embodiment, differing in that the first color light 201 is red, the second color light 202 is green, the third color light 203 is blue, the first mirror 11 is a high transmittance red-transmitting mirror (RTM-HT) and the second mirror 12 is a low transmittance blue-transmitting mirror (BTM-LT). The configuration in this embodiment also redirects the harmful light towards the projection device housing and thus protects the plastic lenses. The effect of this embodiment is similar to that described in the first embodiment.

Referring to FIG. 9, the eighth embodiment of the mirror assembly 1 according to the present invention is substantially similar to the eighth embodiment, only differing in that the first mirror 11 is a high transmittance green-reflecting mirror (GRM-HT). The configuration in this embodiment also redirects the harmful light towards the projection device housing and thus protects the plastic lenses. The effect of this embodiment is similar to that described in the first embodiment.

Generalizing embodiments four to eight, when the third color light 203 includes harmful light and either the first color light 201 or the second color light 202 includes harmful light, that is, when two color lights having harmful light enter the first mirror 11 and the second mirror 12, respectively, the second mirror 12 must have low transmittance (T2), i.e., T2≦8%, to filter out the harmful light from the third color light 203.

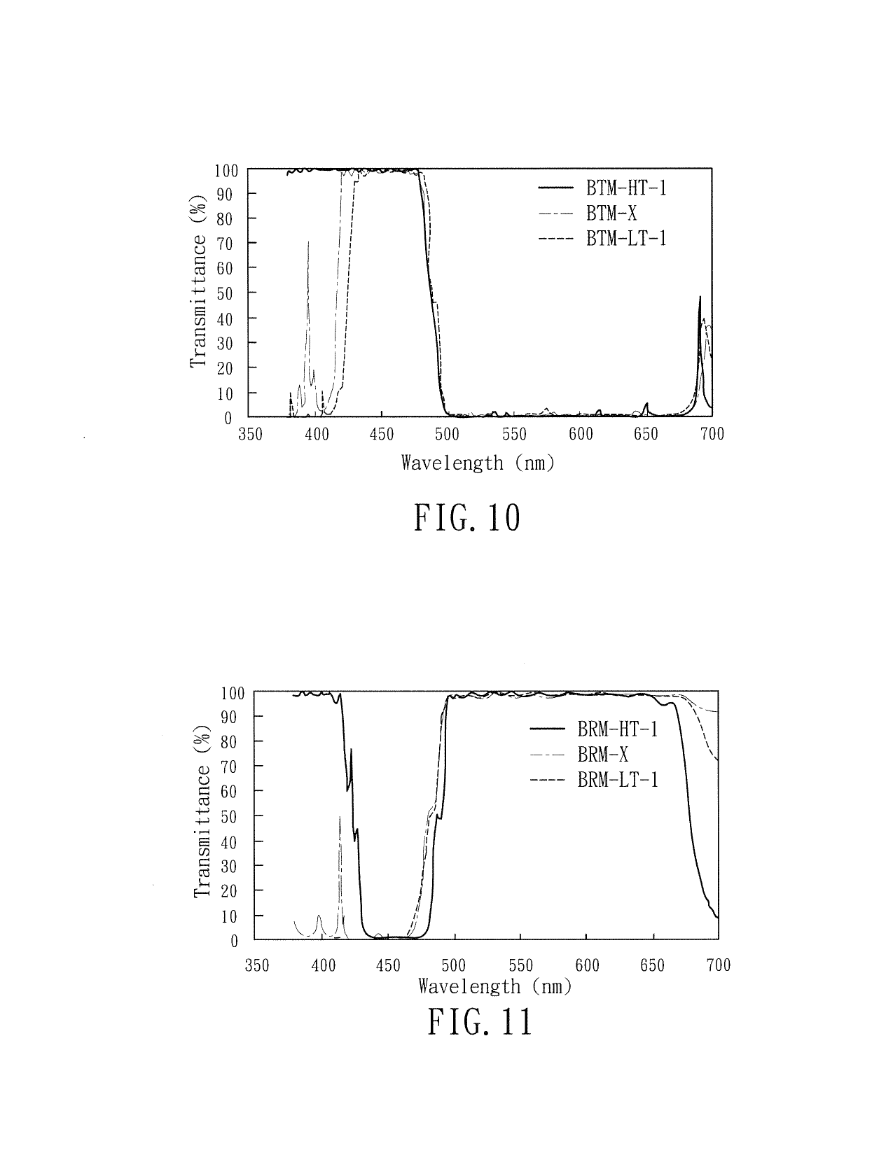

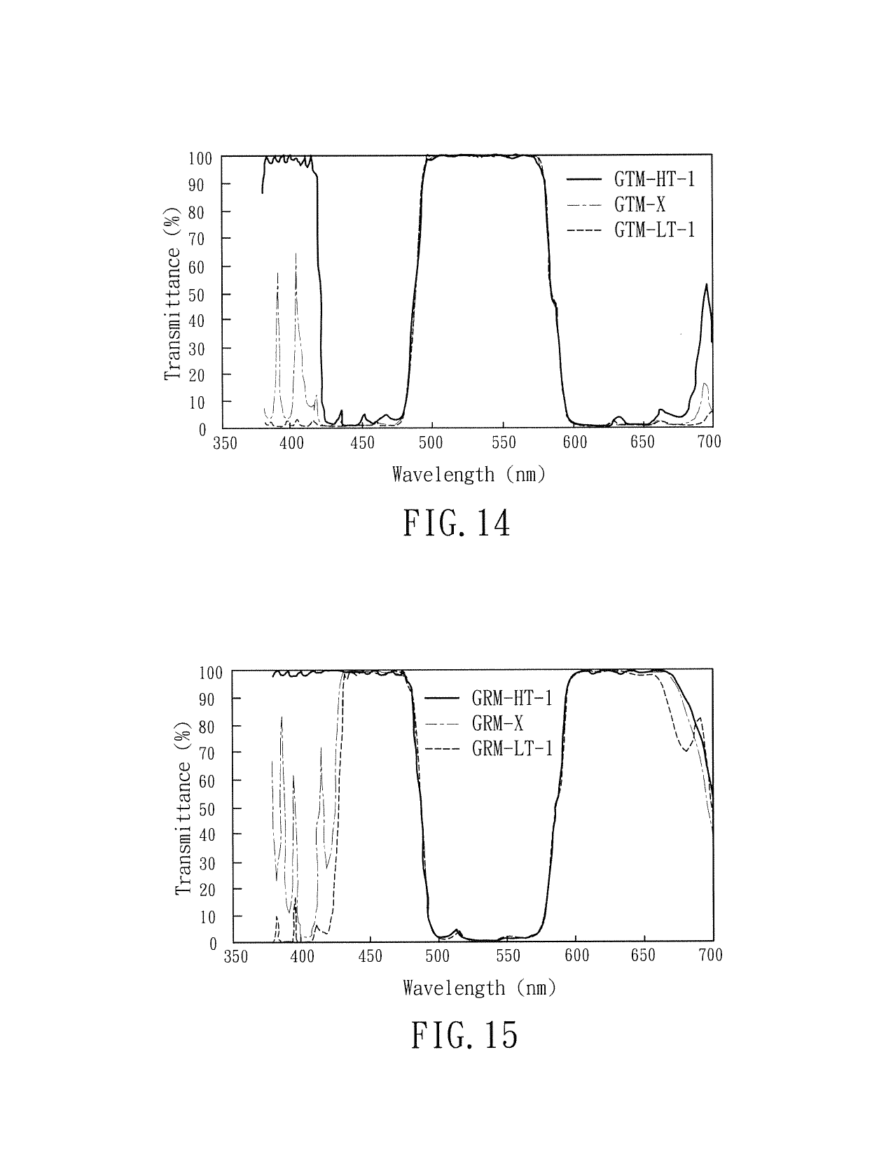

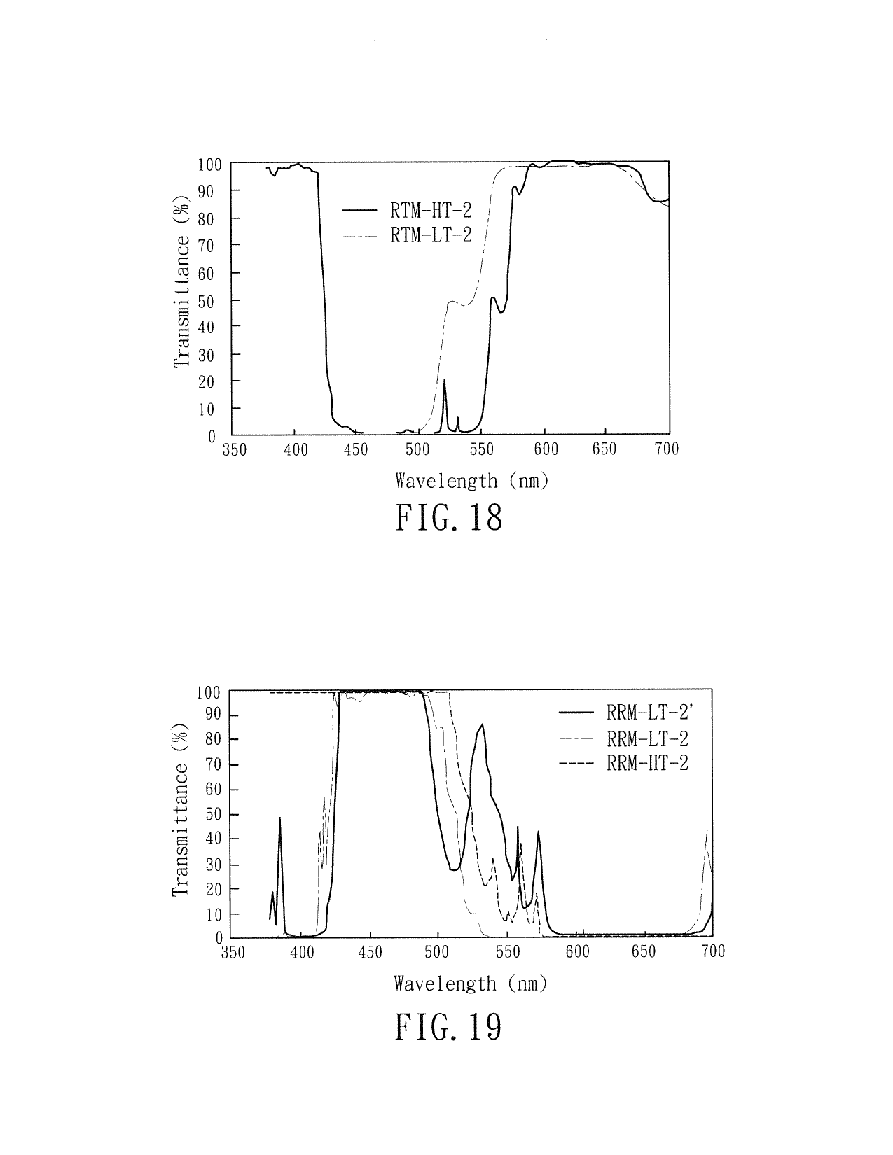

Table 1 lists the parameters of six types of filtering mirrors that can be used as the first mirror 11 or the second mirror 12 of this invention. FIGS. 10 to 19 are graphs that illustrate the transmittance versus wavelength of the filtering mirrors. The first group of high transmittance mirrors (indicated as “HT-1”) and the second group of high transmittance mirrors (indicated as “HT-2”) differ in that the mirrors in HT-2 are designed for BTM, BRM, RTM and RRM and are not as effective in controlling green wavelengths.

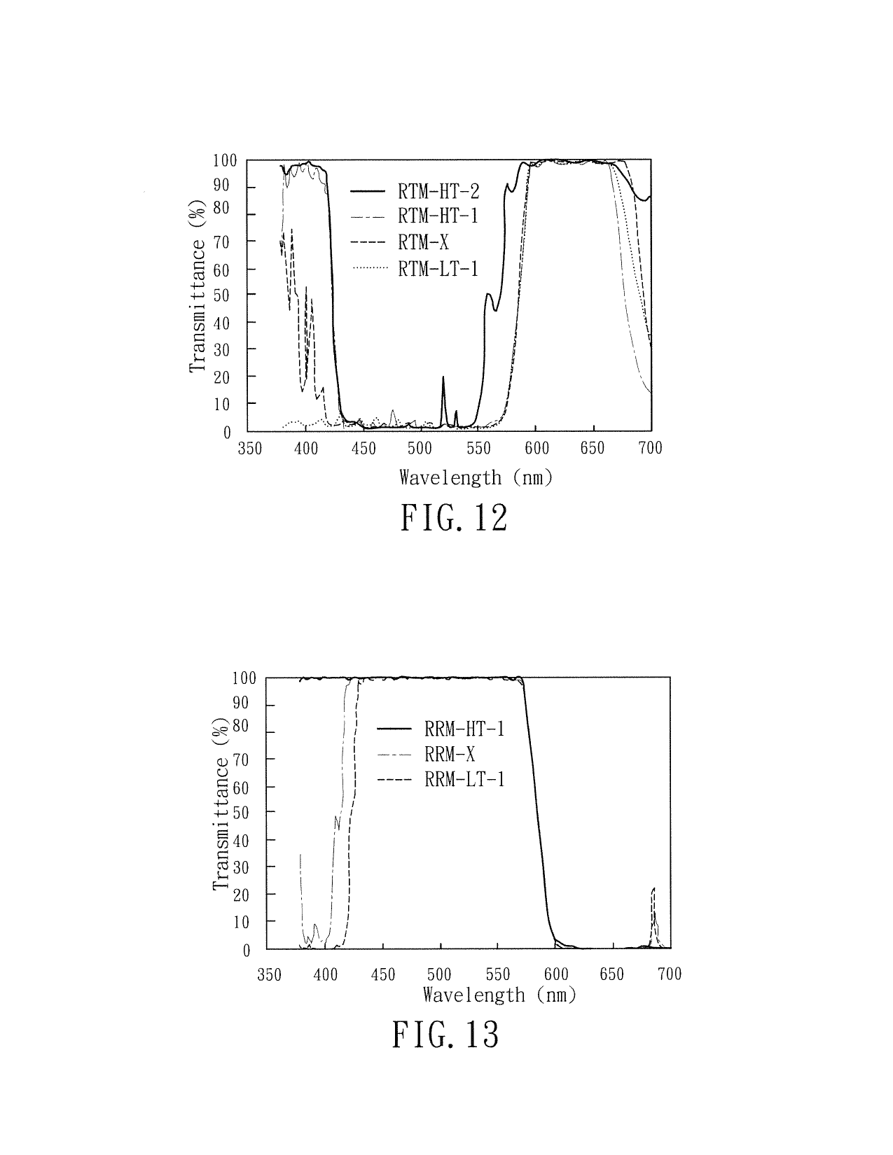

To further explain the differences, taking the transmittance graph for the red-transmitting mirror in FIG. 12 as an example, RTM-HT-1 has high transmittance in the red light area, low transmittance in the blue light area, and high transmittance of light with the wavelength of 380˜420 nm. RTM-HT-2 behaves similarly as RTM-HT-1, however, RTM-HT-2 displays some anomalous fluctuations in the spectrum wavelengths of about 500 nm to 570 nm, meaning that light of that wavelength has not been completely filtered and still has a certain transmittance. Similarly, the difference between the first group of low transmittance mirrors (indicated as “LT-1”) and the second group of low transmittance mirrors (indicated as “LT-2”) resides in that the second group of mirrors has little control over the spectrum range of 500 nm to 570 nm as shown by the anomalous fluctuations in the green light area.

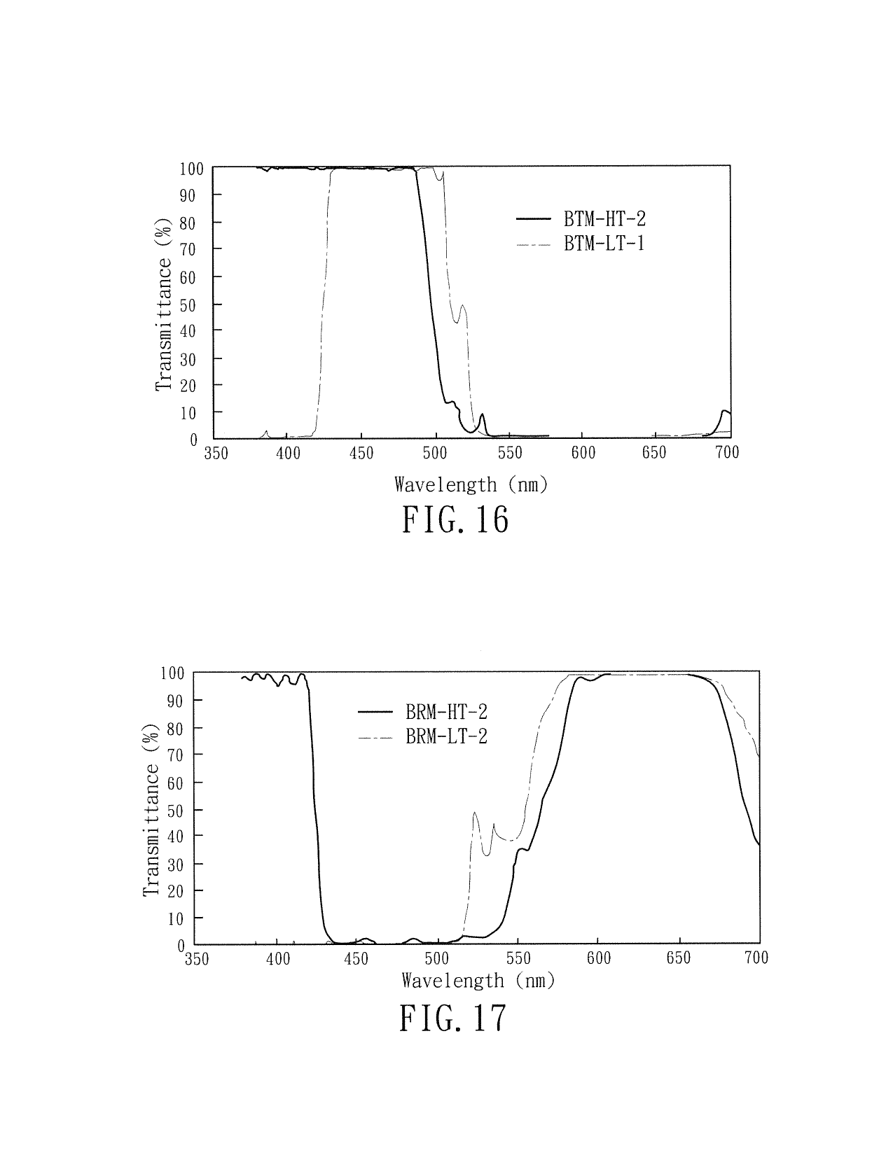

Specifically, as seen in FIG. 12, the first group of RTM, whether RTM-HT-1 or RTM-LT-1, has low average transmittance of light in the wavelength range of 500 nm to 570 nm, as low as 0% and up to 2-3%. On the other hand, the second group of RTM has a higher average transmittance of light in the same wavelength range, and is greater than 5%. Similarly, by comparing the first group of BTM in FIG. 10 and the second group of BTM in FIG. 16, the first group of BTM has a near-zero average transmittance of light in the wavelength range of 500 nm to 570 nm, while the second group of BTM has an average transmittance of light in the same wavelength range greater than 5%.

Additionally, by comparing FIGS. 11 and 17, the first group of BRM in FIG. 11 has near 100% average transmittance of light in the wavelength range of 500 nm to 570 nm, while the second group of BRM in FIG. 17 has an average transmittance of less than 95% of light in the same wavelength range. Similarly, the first group of RRM in FIG. 13 has near 100% average transmittance of light in the wavelength range of 500 nm to 570 nm, while the second group of RRM in FIG. 19 has an average transmittance of less than 95% of light in the same wavelength range.

It should be noted that in FIGS. 10 to 19, the mirrors marked with an “X” are conventional mirrors that have not been specially processed so they neither have high nor low transmittance. Thus, these mirrors do not meet the effects sought by the present invention. Further, FIG. 19 illustrates two types of low transmittance red-reflecting mirrors denoted by RRM-LT-2 and RRM-LT-2′, respectively.

According to Table 1, the second group of mirrors requires fewer coating layers with respect to the first group of mirrors to achieve high or low transmittance of harmful light. This is because the bandwidth that the second group controls is narrower. For example, RRM-HT-1 has 70 coating layers and a 98.5% transmittance, while RRM-HT-2 has only 50 coating layers and can achieve a 98.5% transmittance. Also for example, BTM-LT-1 has 71 coating layers and a 3.4% transmittance, while BTM-LT-2 has only 57 coating layers and can achieve a 3.4% transmittance. Thus, using the second group of mirrors can decrease costs.

TABLE 1

| | | BTM | BRM | RTM | RRM | GTM | GRM |
|---|---|---|---|---|---|---|---|
| HT-1 | Average | 98.3 | 95.8 | 96.6 | 98.5 | 87.5 | 97.3 |
| | transmittance | | | | | | |
| | (%) of harmful | | | | | | |
| | light | | | | | | |
| | Number of | 55 | 39 | 72 | 70 | 65 | 61 |
| | Coating layers | | | | | | |
| HT-2 | Average | 99.2 | 96.6 | 96.1 | 98.9 | | |
| | transmittance | | | | | | |
| | (%) of harmful | | | | | | |
| | light | | | | | | |
| | Number of | 55 | 41 | 48 | 50 | | |
| | Coating layers | | | | | | |
| LT-1 | Average | 3.4 | 0.1 | 2.1 | 2.1 | 1.6 | 4.0 |
| | transmittance | | | | | | |
| | (%) of harmful | | | | | | |
| | light | | | | | | |
| | Number of | 71 | 49 | 43 | 68 | 62 | 51 |
| | Coating layers | | | | | | |
| LT-2 | Average | 2.9 | 0.2 | 0.2 | 6.4 | | |
| | transmittance | | | | | | |
| | (%) of harmful | | | | | | |
| | light | | | | | | |
| | Number of | 57 | 39 | 38 | 54 | | |
| | Coating layers | | | | | | |

With reference to Table 1, HT-1 and LT-1 mirrors, which are more efficient at controlling green wavelengths, may be used as the first mirror 11 or the second mirror 12 of this invention. On the other hand, HT-2 and LT-2 mirrors, which are less efficient at controlling the green wavelength range (500 nm˜570 nm), are suitable for use as the first mirror 11 of this invention. For example, in the embodiments shown in FIGS. 5 and 6, the first mirror 11 can use a mirror of the second group (HT-2 or LT-2) coupled with the third color light 203 that is green and the second mirror 12 that is a low transmittance green-transmitting mirror (GTM-LT). An advantage to using a mirror from the second group as the first mirror 11 is that since filtering or reflecting of green wavelength by the second group of mirrors is loosely controlled with respect to that of the first group of mirrors, portions of blue and red lights can pass through or reflect toward the second mirror 12. That is, light intensity reaching the second mirror 12 from the first mirror 11 can be increased, thereby enhancing the output efficiency and brightness of the projection device 2.

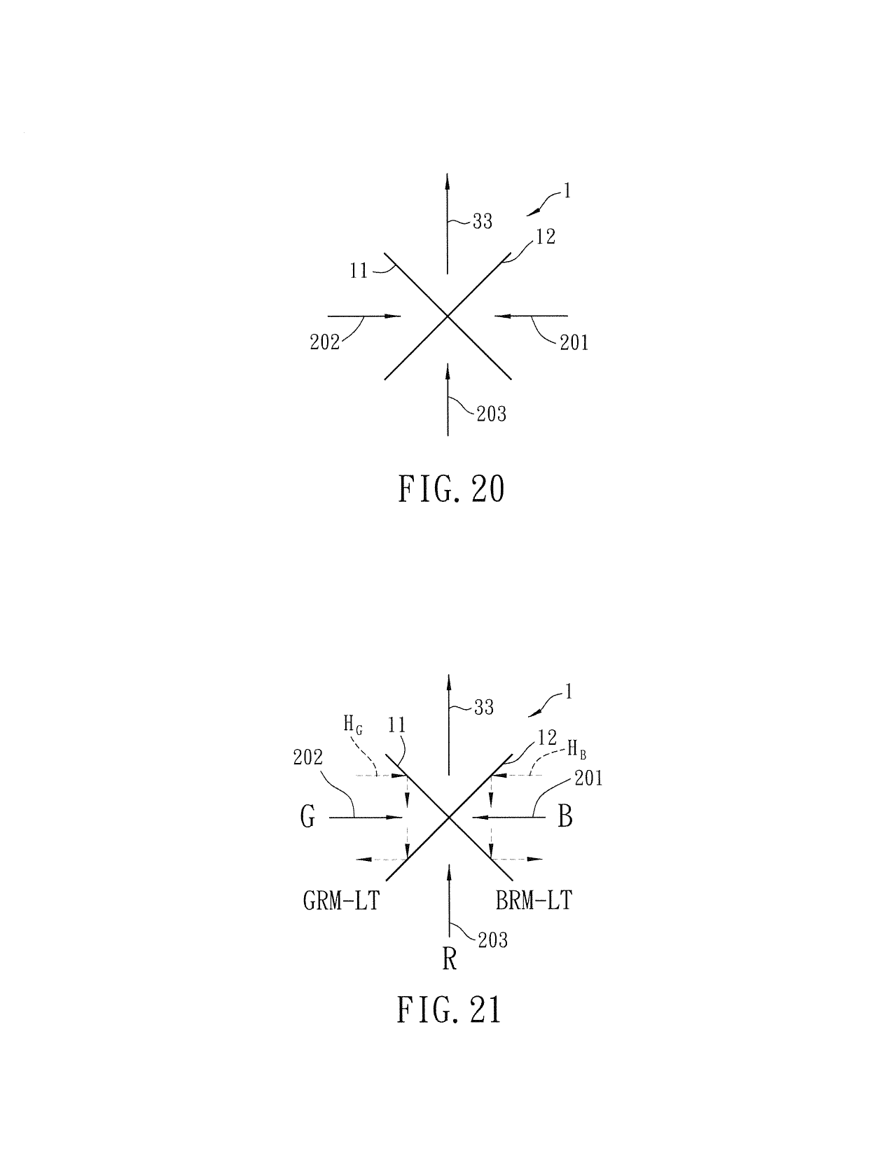

Referring to FIG. 20, the mirror assembly 1 of the present invention may also be configured as an X-plate or a cross-dichroic filter which is formed by at least two mirrors intersecting in an X shape. Specifically, the mirror assembly 1 comprises a first mirror 11 and a second mirror 12. The first mirror 11 reflects a first color light 201 toward a combined direction 33 and has an average transmittance of less than or equal to of light in the wavelength range of 380˜420 nm. The second mirror 12 intersects the first mirror 11 and reflects a second color light 202 toward the combined direction 33. The second mirror also has an average transmittance T2 of less than or equal to 8%. A third color light 203 passes through the second mirror 12 and the first mirror 11 and travels toward the combined direction 33 to combine with the first color light 201 and the second color light 202.

The cross-dichroic mirror used as the mirror assembly 1 of this invention can similarly combine the three RGB colors of light, and filters out harmful light having wavelengths of 380-420 nm, as will be described in the following three embodiments.

FIG. 21 illustrates the ninth embodiment of the mirror assembly 1 according to this invention. In this embodiment, the first color light 201 is blue, the second color light 202 is green, and the third color light 203 is red. The first mirror 11 is a low transmittance blue-reflecting mirror (BRM-LT) and the second mirror 12 is a low transmittance green-reflecting mirror (GRM-LT) that intersects the first mirror 11. The first color or blue light 201 is reflected upwardly by the first mirror 11 and the second color or green light 202 is reflected upwardly by the second mirror 12, both toward the combined direction 33. The third color or red light 203 passes upwardly through the first mirror 11 and the second mirror 12 to combine with the first and second color lights 201, 202. Harmful lights (denoted by imaginary lines H_{B}, H_{G}) carried by the blue light 201 and the green light 202 are reflected by the first mirror 11 and the second mirror 12, respectively, so that the harmful lights cannot pass through the first and second mirrors 11, 12. That is, the harmful lights are filtered out and cannot travel toward the combined direction 33. This prevents the harmful lights from reaching and damaging any of the subsequent lenses.

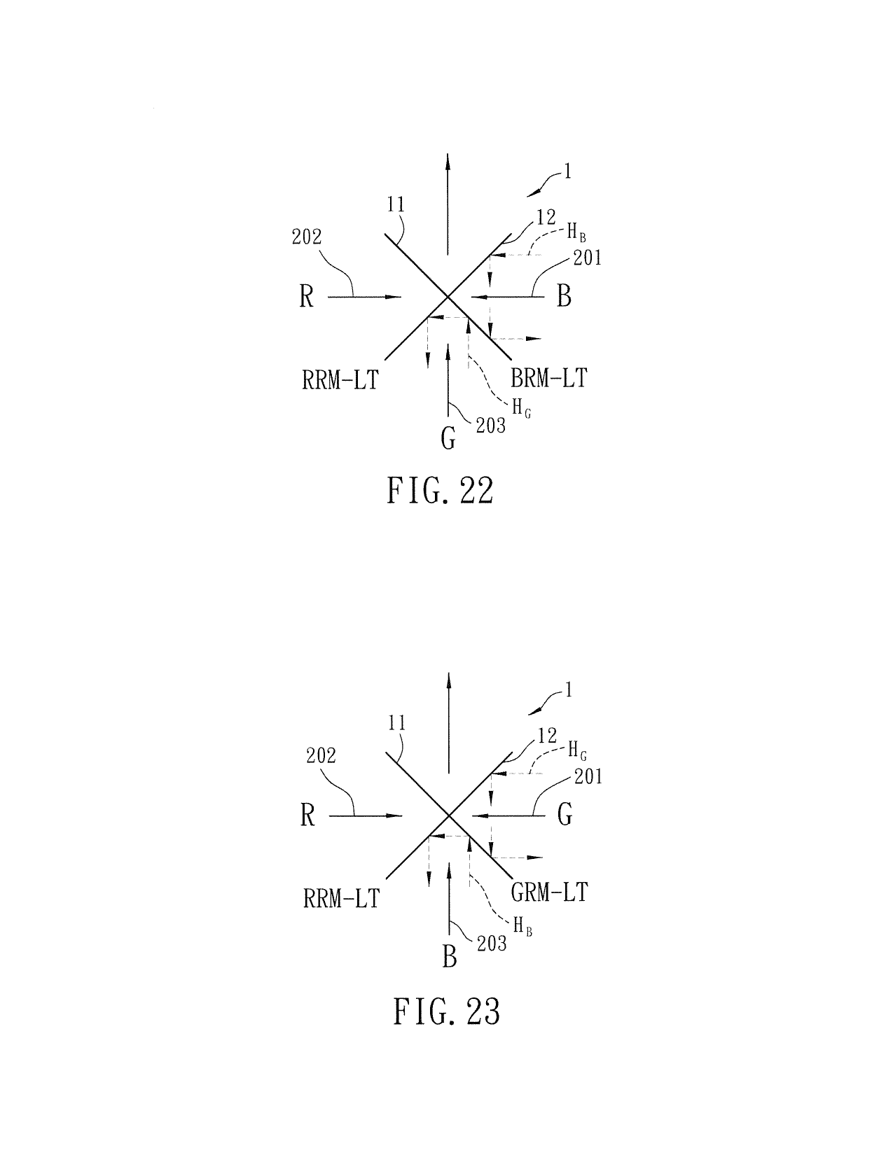

Referring to FIG. 22, the tenth embodiment of the mirror assembly 1 according to this invention has the same basic structure as the ninth embodiment. However, in this embodiment, the second color light 202 is red, the third color light 203 is green, the first mirror is a low transmittance blue-reflecting mirror (BRM-LT) and the second mirror 12 is a low transmittance red-reflecting mirror (RRM-LT). The configuration in this embodiment can similarly filter out the harmful lights. The effect of this embodiment is similar to that described in the ninth embodiment.

Referring to FIG. 23, the eleventh embodiment of the mirror assembly 1 according to this invention has the same basic structure as the ninth embodiment. However, in this embodiment, the first color light 201 is green, the second color light 202 is red, the third color light 203 is blue, the first mirror 11 is a low transmittance green-reflecting mirror (GRM-LT) and the second mirror 12 is a low transmittance red-reflecting mirror (RRM-LT). The configuration in this embodiment can similarly filter out the harmful lights. The effect of this embodiment is similar to that described in the ninth embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mirror assembly for combining visible lights with a filter function, comprising:
a first mirror configured to pass a first color light therethrough and reflect a second color light, said first color light traveling in a first direction, said first mirror extending in a direction non-perpendicular to said first direction and having an average transmittance (T1) of light with a wavelength of 380 nm to 420 nm, T1 being less than or equal to 8% (T1≦8%) or greater than or equal to 95% (T1≧95%); and
a second mirror disposed at one side said first mirror and extending in a direction non-perpendicular to said first direction, said second mirror being configured to reflect said first color light and said second color light from said first mirror and to pass a third color light therethrough so as to mix said third color light with said first and second color lights, said second mirror having an average transmittance (T2) of light with a wavelength of 380 nm to 420 nm, T2 being less than or equal to 8% (T2≦8%) or greater than or equal to 95% (T2≧95%);
wherein said first color light, said second color light, and said third color light are combined at one side of said second mirror, while light having a wavelength of 380 nm to 420 nm travels from the other side of said second mirror.

2. The mirror assembly as claimed in claim 1, wherein each of said first color light and said second color light includes light with a wavelength of 380 nm to 420 nm, and T2 is greater than or equal to 95% (T2≧95%).

3. The mirror assembly as claimed in claim 2, wherein said first color light is green, said second color light is blue, said third color light is red, said first mirror is a blue-reflecting mirror, and said second mirror is a red-transmitting mirror.

4. The mirror assembly as claimed in claim 2, wherein said first color light is blue, said second color light is green, said third color light is red, said first mirror is a blue-transmitting mirror or a green-reflecting mirror, and said second mirror is a red-transmitting mirror.

5. The mirror assembly as claimed in claim 1, wherein one of said first color light and said second color light includes light with a wavelength of 380 nm to 420 nm, said third color light includes light with a wavelength of 380 nm to 420 nm, and T2 is less than or equal to 8% (T2≦8%).

6. The mirror assembly as claimed in claim 5, wherein said first color light is red, said second color light is blue, said third color light is green, said first mirror is a blue-reflecting mirror or a red-transmitting mirror having T1 that is greater than or equal to 95% (T1≧95%), and said second mirror is a green-transmitting mirror.

7. The mirror assembly as claimed in claim 5, wherein said first color light is blue, said second color light is red, said third color light is green, said first mirror is a blue-transmitting mirror or a red-reflecting mirror having T1 that is less than or equal to 8% (T1≦8%), and said second mirror is a green-transmitting mirror.

8. The mirror assembly as claimed in claim 5, wherein said first color light is green, said second color light is red, said third color light is blue, said first mirror is a red-reflecting mirror, and said second mirror is a blue-transmitting mirror.

9. The mirror assembly as claimed in claim 5, wherein said first color light is red, said second color light is green, said third color light is blue, said first mirror is a red-transmitting mirror or a green-reflecting mirror, and said second mirror is a blue-transmitting mirror.

10. The mirror assembly as claimed in claim 6, wherein said first mirror is a blue-reflecting mirror having an average transmittance of less than 95% for light with a wavelength of 500 nm to 570 nm.

11. The mirror assembly as claimed in claim 6, wherein said first mirror is a red-transmitting mirror having an average transmittance of greater than 5% for light with a wavelength of 500 nm to 570 nm.

12. The mirror assembly as claimed in claim 7, wherein said first mirror is a red-reflecting mirror having an average transmittance of less than 95% for light with a wavelength of 500 nm to 570 nm.

13. The mirror assembly as claimed in claim 7, wherein said first mirror is a blue-transmitting mirror having an average transmittance of greater than 5% for light with a wavelength of 500 nm to 570 nm.

14. A mirror assembly for combining visible lights with a filter function, comprising:
a first mirror that reflects a first color light toward a combined direction and that has an average transmittance of less than or equal to 8% of light with a wavelength of 380 nm to 420 nm; and
a second mirror that intersects said first mirror, that reflects a second color light toward said combined direction, and that has an average transmittance of less than or equal to 8% of light with a wavelength of 380 nm to 420 nm;
wherein a third color light passes through said first mirror and said second mirror in said combined direction to combine with said first color light and said second color light.

15. The mirror assembly as claimed in claim 14, wherein said mirror assembly is an X-plate.

16. The mirror assembly as claimed in claim 14, wherein said first color light is blue, said second color light is green, said third color light is red, said first mirror is a blue-reflecting mirror, and said second mirror is a green-reflecting mirror.

17. The mirror assembly as claimed in claim 14, wherein said first color light is blue, said second color light is red, said third color light is green, said first mirror is a blue-reflecting mirror, and said second mirror is a red-reflecting mirror.

18. The mirror assembly as claimed in claim 14, wherein said first color light is green, said second color light is red, said third color light is blue, said first mirror is a green-reflecting mirror, and said second mirror is a red-reflecting mirror.
